(19) United States
(12) Patent Application Publication
(10) Pub. No.: US 2013/0316088 A1
(43) Pub. Date: Nov. 28, 2013

(54) MAGNETIC RECORDING HEAD MANUFACTURING METHOD

(71) Applicant: KABUSHIKI KAISHA TOSHIBA, Tokyo (JP)

(72) Inventors: Norihito FUJITA, Fuchu-shi (JP); Shinobu SUGIMURA, Yokohama-shi (JP); Satoshi SHIROTORI, Yokohama-shi (JP); Tomohiko NAGATA, Yokohama-shi (JP); Akio HORI, Kawasaki-shi (JP); Tomomi FUNAYAMA, Fuchu-shi (JP)

(73) Assignee: KABUSHIKI KAISHA TOSHIBA, Tokyo (JP)

(21) Appl. No.: 13/706,157

(22) Filed: Dec. 5, 2012

(30) Foreign Application Priority Data
May 25, 2012 (JP) 2012-120208

(51) Int. Cl. G11B 5/84

(52) U.S. Cl. CPC G11B 5/84
USPC 427/526; 427/131

(57) ABSTRACT

According to one embodiment, a magnetic recording head manufacturing method characterized by includes processes of forming a main pole, forming, on the main pole, an insulating layer having a gap for forming a spin torque oscillator, forming a spin torque oscillator in the gap, and forming an auxiliary magnetic pole on the spin torque oscillator is provided.

### CROSS-REFERENCE TO RELATED APPLICATIONS

This application is based upon and claims the benefit of priority from Japanese Patent Application No. 2012-120208, filed May 25, 2012, the entire contents of which are incorporated herein by reference.

### FIELD

Embodiments described herein relate generally to a magnetic recording head manufacturing method.

### BACKGROUND

Perpendicular magnetic recording more advantageous for high-density recording in principle than longitudinal magnetic recording is increasing the recording density of a hard disk drive (HDD) by about 40% per year. It is, however, probably not easy to achieve a high recording density even when using the perpendicular magnetic recording method because the problem of thermal decay becomes serious again.

“A high-frequency field assisted magnetic recording method” has been proposed as a recording method capable of solving this problem. In this high-frequency field assisted magnetic recording method, a high-frequency magnetic field much higher than a recording signal frequency and close to the resonance frequency of a magnetic recording medium is locally applied to it. Consequently, the medium resonates, and the magnetic coercive force (Hc) of the medium in the portion to which the high-frequency magnetic field is applied becomes half the original coercive force or less. By using this effect, it is possible, by superposing a high-frequency magnetic field on a recording field, to perform magnetic recording on a medium having a higher coercive force (Hc) and a higher magnetic anisotropic energy (Ku). If a high-frequency magnetic field is generated by using a coil, however, it becomes difficult to efficiently apply the high-frequency magnetic field to a medium.

As a high-frequency magnetic field generating means, therefore, a method using a spin torque oscillator (STO) has been proposed. In the disclosed technique, the spin torque oscillator includes a spin injection layer (SIL), interlayer, field generation layer (FGL) {oscillation layer}, and electrode. When a direct current is supplied to the spin torque oscillator through the electrode, magnetization in the magnetic material layer causes ferromagnetic resonance due to the spin torque generated by the spin transfer layer. As a consequence, the spin torque oscillator generates a high-frequency magnetic field.

When forming a magnetic recording head using the spin torque oscillator, it is possible to form a mask on the spin torque oscillator by photolithography or the like, and physically etching the spin torque oscillator and a main pole at once by performing ion milling, thereby forming a pattern. Unfortunately, this method has the problem that the magnetic material contained in the spin torque oscillator or main pole is redeposited on the sidewalls of the spin torque oscillator and deteriorates the oscillation characteristic of the spin torque oscillator.

### BRIEF DESCRIPTION OF THE DRAWINGS

FIG. 1A is a view showing a magnetic recording head manufacturing process according to the first embodiment;

FIG. 1B is a view showing another magnetic recording head manufacturing process according to the first embodiment;

FIG. 1C is a view showing still another magnetic recording head manufacturing process according to the first embodiment;

FIG. 1D is a view showing still another magnetic recording head manufacturing process according to the first embodiment;

FIG. 1E is a view showing still another magnetic recording head manufacturing process according to the first embodiment;

FIG. 1F is a view showing still another magnetic recording head manufacturing process according to the first embodiment;

FIG. 1G is a view showing still another magnetic recording head manufacturing process according to the first embodiment;

FIG. 1H is a view showing still another magnetic recording head manufacturing process according to the first embodiment;

FIG. 1I is a view showing still another magnetic recording head manufacturing process according to the first embodiment;

FIG. 1J is a view showing still another magnetic recording head manufacturing process according to the first embodiment;

FIG. 1K is a view showing still another magnetic recording head manufacturing process according to the first embodiment;

FIG. 1L is a view showing still another magnetic recording head manufacturing process according to the first embodiment;

FIG. 1M is a view showing still another magnetic recording head manufacturing process according to the first embodiment;

FIG. 1N is a view showing still another magnetic recording head manufacturing process according to the first embodiment;

FIG. 1O is a view showing still another magnetic recording head manufacturing process according to the first embodiment;

FIG. 1P is a view showing still another magnetic recording head manufacturing process according to the first embodiment;

FIG. 1Q is a view showing still another magnetic recording head manufacturing process according to the first embodiment;

FIG. 2 is a sectional view showing the arrangement of an embodiment of an STO layer;

FIG. 3A is a view showing a magnetic recording head manufacturing process according to the second embodiment;

FIG. 3B is a view showing another magnetic recording head manufacturing process according to the second embodiment;

FIG. 3C is a view showing still another magnetic recording head manufacturing process according to the second embodiment;

FIG. 3D is a view showing still another magnetic recording head manufacturing process according to the second embodiment;

FIG. 3E is a view showing still another magnetic recording head manufacturing process according to the second embodiment;

FIG. 3F is a view showing still another magnetic recording head manufacturing process according to the second embodiment;

FIG. 3G is a view showing still another magnetic recording head manufacturing process according to the second embodiment;

FIG. 3H is a view showing still another magnetic recording head manufacturing process according to the second embodiment;

FIG. 3I is a view showing still another magnetic recording head manufacturing process according to the second embodiment;

FIG. 3J is a view showing still another magnetic recording head manufacturing process according to the second embodiment;

FIG. 3K is a view showing still another magnetic recording head manufacturing process according to the second embodiment;

FIG. 3L is a view showing still another magnetic recording head manufacturing process according to the second embodiment;

FIG. 3M is a view showing still another magnetic recording head manufacturing process according to the second embodiment;

FIG. 3N is a view showing still another magnetic recording head manufacturing process according to the second embodiment;

FIG. 3O is a view showing still another magnetic recording head manufacturing process according to the second embodiment;

FIG. 3P is a view showing still another magnetic recording head manufacturing process according to the second embodiment;

FIG. 3Q is a view showing still another magnetic recording head manufacturing process according to the second embodiment;

FIG. 3R is a view showing still another magnetic recording head manufacturing process according to the second embodiment;

FIG. 3S is a view showing still another magnetic recording head manufacturing process according to the second embodiment;

FIG. 4A is a view showing a magnetic recording head manufacturing process according to the third embodiment;

FIG. 4B is a view showing another magnetic recording head manufacturing process according to the third embodiment;

FIG. 4C is a view showing still another magnetic recording head manufacturing process according to the third embodiment;

FIG. 4D is a view showing still another magnetic recording head manufacturing process according to the third embodiment;

FIG. 4E is a view showing still another magnetic recording head manufacturing process according to the third embodiment;

FIG. 4F is a view showing still another magnetic recording head manufacturing process according to the third embodiment;

FIG. 4G is a view showing still another magnetic recording head manufacturing process according to the third embodiment;

FIG. 4H is a view showing still another magnetic recording head manufacturing process according to the third embodiment;

FIG. 4I is a view showing still another magnetic recording head manufacturing process according to the third embodiment;

FIG. 4J is a view showing still another magnetic recording head manufacturing process according to the third embodiment;

FIG. 4K is a view showing still another magnetic recording head manufacturing process according to the third embodiment;

FIG. 4L is a view showing still another magnetic recording head manufacturing process according to the third embodiment;

FIG. 4M is a view showing still another magnetic recording head manufacturing process according to the third embodiment;

FIG. 4N is a view showing still another magnetic recording head manufacturing process according to the third embodiment;

FIG. 4O is a view showing still another magnetic recording head manufacturing process according to the third embodiment;

FIG. 4P is a view showing still another magnetic recording head manufacturing process according to the third embodiment;

FIG. 4Q is a view showing still another magnetic recording head manufacturing process according to the third embodiment; and

FIG. 4R is a view showing still another magnetic recording head manufacturing process according to the third embodiment.

### DETAILED DESCRIPTION

A magnetic recording head manufacturing method according to an embodiment includes forming a main pole, forming, on the main pole, an insulating layer having a gap for forming a spin torque oscillator, forming the spin torque oscillator in the gap, and forming an auxiliary magnetic pole on the spin torque oscillator.

Also, a magnetic recording head manufacturing method according to an embodiment can include

forming a main pole,

forming a mask layer on the main pole,

patterning the main pole through the mask layer,

forming an insulating layer on the main pole and mask layer,

exposing the mask layer by partially removing the insulating layer, and

forming a gap for forming a spin torque oscillator in the insulating layer by removing the mask layer, forming a spin torque oscillator in the gap, and forming an auxiliary magnetic pole on the spin torque oscillator.

In the embodiment, the spin torque oscillator is formed in the gap in the insulating layer. Therefore, the sidewalls of the spin torque oscillator are not exposed to dry etching such as ion beam etching, so there is no redeposited product of the main pole material, which suppresses the oscillation of the spin torque oscillator. Accordingly, a critical current density Jc necessary for oscillation is suppressed in the magnetic recording head according to the embodiment. This makes it possible to maximally utilize a high-frequency magnetic field of the spin torque oscillator, and increase the recording gain. In the embodiment, therefore, a magnetic recording head can be manufactured without deteriorating the oscillation characteristic of the spin torque oscillator.

In the above-mentioned method, one of a resist layer and hard mask layer can be used as the mask layer.

Also, in the above-mentioned method, forming the spin torque oscillator in the gap can include forming the spin torque oscillator by ion beam sputtering on the insulating layer having the gap, and removing the spin torque oscillator formed in a region except for the gap by scraping the spin torque oscillator.

In the first embodiment, forming the main pole can include forming the main pole in a trench formed in a nonmagnetic layer.

Also, the second embodiment can include forming a magnetic shield layer on the insulating layer and partially removing the magnetic shield layer, before exposing the mask layer by partially removing the insulating layer.

The embodiments will be explained below with reference to the accompanying drawings.

### First Embodiment

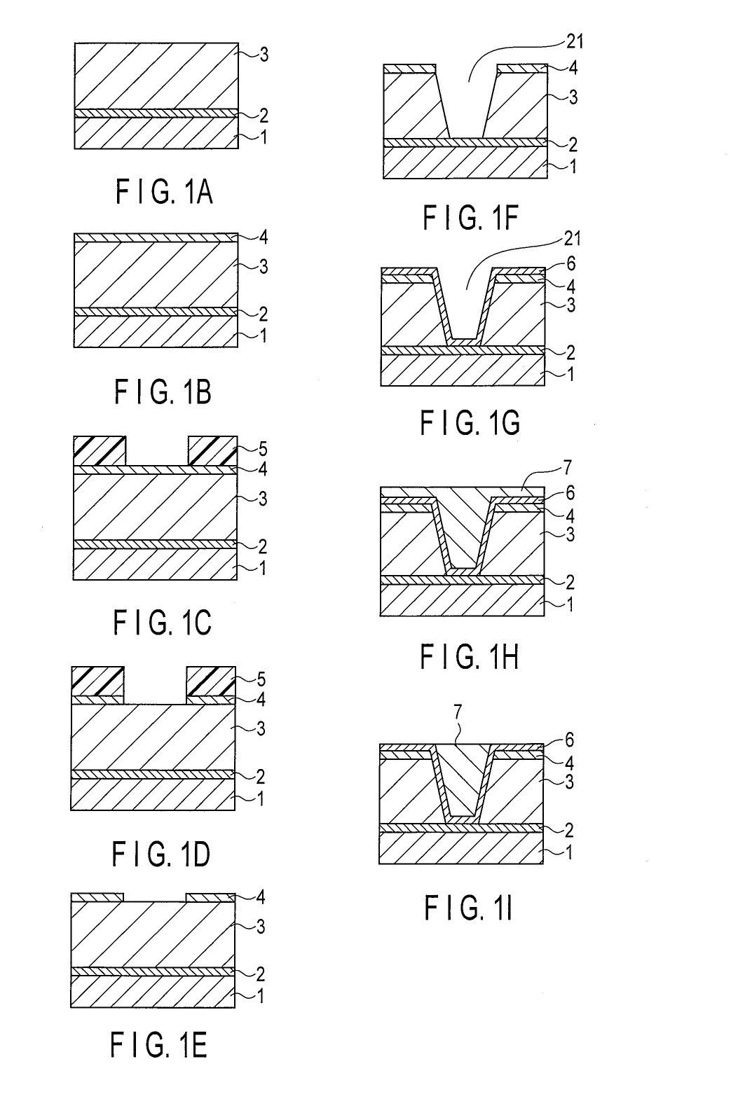

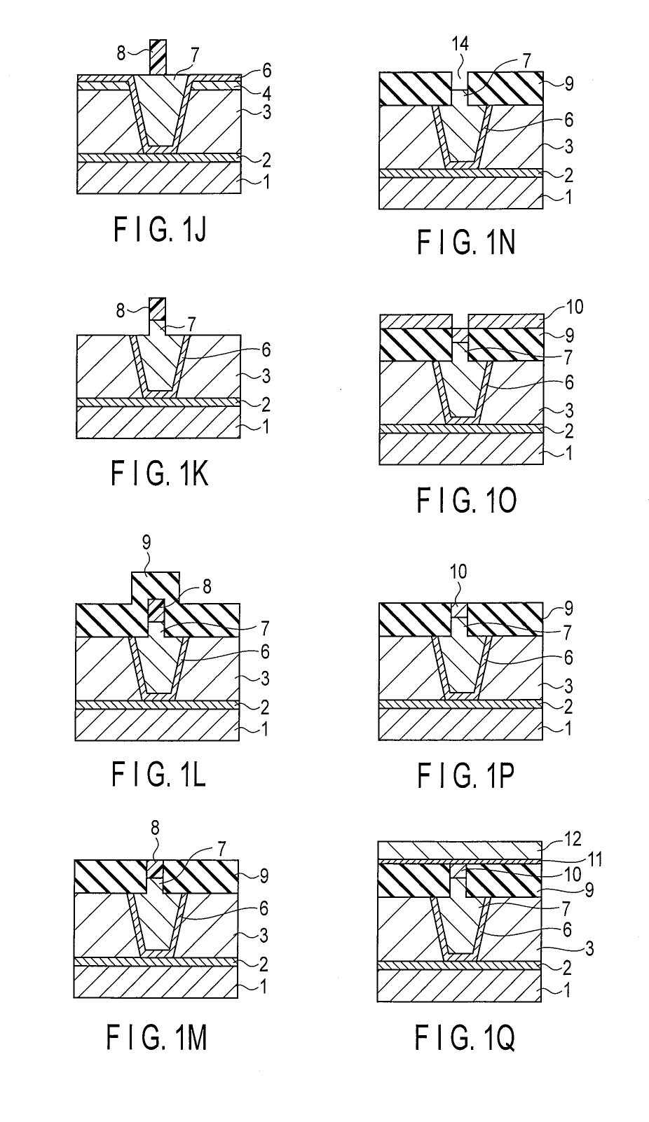

FIGS. 1A, 1B, 1C, 1D, 1E, 1F, 1G, 1H, 1I, 1J, 1K, 1L, 1M, 1N, 1O, 1P, and 1Q are views showing magnetic recording head manufacturing processes according to the first embodiment.

First, a reader using an MR sensor is formed on an AlTiC (Al₂O₃—TiC) substrate by a known method. Since Al₂O₃ or the like is used in order to adjust the spacing between the reader and a writer after the reader is formed, as shown in FIG. 1A, the obtained substrate is represented by an Al₂O₃ substrate 1. A etch stopper layer 2 and Al₂O₃ layer 3 are formed on the substrate 1. The etch stopper layer 2 controls RIE (Reactive Ion Etching) using a reactive gas in the depth direction when forming a trench in the Al₂O₃ layer, and can have a thickness of 10 to 50 nm. Although the material depends on the reactive gas to be used, it is possible to use a material having an etching rate lower than that of the Al₂O₃ layer 3 to be etched. An example is Ru. The Al₂O₃ layer 3 is formed by PVD (Physical Vapor Deposition) or CVD (Chemical Vapor Deposition). The film thickness of the Al₂O₃ layer 3 must be defined by taking account of the thickness of a main pole to be buried later.

Then, as shown in FIG. 1B, after the Al₂O₃ layer 3 is deposited, a metal mask 4 for patterning the Al₂O₃ layer 3 is deposited. The metal mask 4 can be made of a material that sufficiently increases the selectivity to the Al₂O₃ layer 3 during etching. An example is Ru.

Subsequently, as shown in FIG. 1C, after the metal mask 4 is deposited, a resist pattern 5 for patterning the metal mask 4 is formed. Resist patterning is performed using photolithography, electron beam lithography, or the like. Although a photoresist is generally used, it is also possible to use a hard mask made of, e.g., C, Si, Al, or an oxide or nitride of these elements.

Furthermore, as shown in FIG. 1D, after the resist pattern 5 is formed, metal mask etching is performed to transfer the pattern to the metal mask 4. For example, the metal mask is physically etched by Ion Beam Etching (IBE). IBE is a method of etching a target by bombarding accelerated ions, and a designer can properly adjust the bombardment angle.

As shown in FIG. 1E, the photoresist pattern 5 is removed after the metal mask is etched. This removal is performed by wet removal using a release solution such as NMP (N-methyl-2-pyrrolidone), or dry removal such as RIE using a reactive gas.

After that, as shown in FIG. 1F, after the photoresist is removed, the Al₂O₃ layer 3 is etched by using the patterned metal mask as a mask, thereby forming a trench 21. For example, the Al₂O₃ layer 3 is etched by RIE using a reactive gas. Since the etch stopper layer 2 formed below the Al₂O₃ layer 3 can make the end point of etching clearer, a stable, robust process can be performed.

As shown in FIG. 1G, after the trench 21 is formed in the Al₂O₃ layer 3, a seed layer 6 is deposited in order to plate a main pole. A nonmagnetic metal having high conductivity can be used as the seed layer 6. An example is Ru.

As shown in FIG. 1H, a main pole 7 is formed by plating after the seed layer 6 is formed. Although the main pole 7 is formed by plating in this embodiment, a dry process such as sputtering may also be used. Since the main pole 7 is required to have a high saturation magnetic flux density (Bs), alloys materials of Fe, Co, and Ni can be used.

As shown in FIG. 1I, after the main pole 7 is formed, the surface is planarized by CMP (Chemical Mechanical Polishing) in order to planarize the surface of the main pole 7. In this process, Ru used in the seed layer 6 functions as a CMP stopper, thereby implementing a stable, robust process.

Furthermore, as shown in FIG. 1J, a mask 8 is formed on the main pole 7 in order to perform patterning for scraping the main pole 7. Photolithography, electron beam lithography, or the like is used as this patterning. Although a photoresist or the like is used as the mask 8, it is also possible to use a hard mask made of, e.g., C, Si, Al, or an oxide or nitride of these elements. The width can be about 30 to 70 nm to match the width of an STO (Spin Torque Oscillator).

Subsequently, as shown in FIG. 1K, the main pole 7 is etched by IBE by using the pattern formed by, e.g., photolithography or electron beam lithography as the mask 8. The etching depth can be 50 to 100 nm.

As shown in FIG. 1L, an insulating layer 9 is formed after the main pole 7 is etched. The thickness of the insulating layer 9 must be determined by taking account of the etching depth of the main pole 7, and the thickness of an STO to be formed later. The insulating layer 9 can be an oxide such as SiO₂ or Al₂O₃, or a nitride such as Si₃N₄ or AlN.

As shown in FIG. 1M, after the insulating layer 9 is formed, the surface of the resist used as the mask 8 for etching the main pole 7 is exposed. The photoresist surface can be exposed by performing, e.g., a planarizing process by using CMP, but IBE may also be used.

As shown in FIG. 1N, after the surface of the photoresist used as the mask 8 is exposed by the planarizing process using CMP, a gap 14 for forming an STO can be formed by removing the photoresist. This realizes a state in which an STO can be formed in self-alignment. As this removal, it is possible to use wet removal using a solution that dissolves the resist, or dry removal such as RIE using a reactive gas.

After that, as shown in FIG. 1O, an STO 10 is formed on the main pole 7 after the resist is removed. Since the STO 10 is buried in the gap 14, it is deposited by using IBD (Ion Beam Deposition) as a deposition method having high atomic linearity, thereby suppressing deposition to the sidewalls of the gap 14.

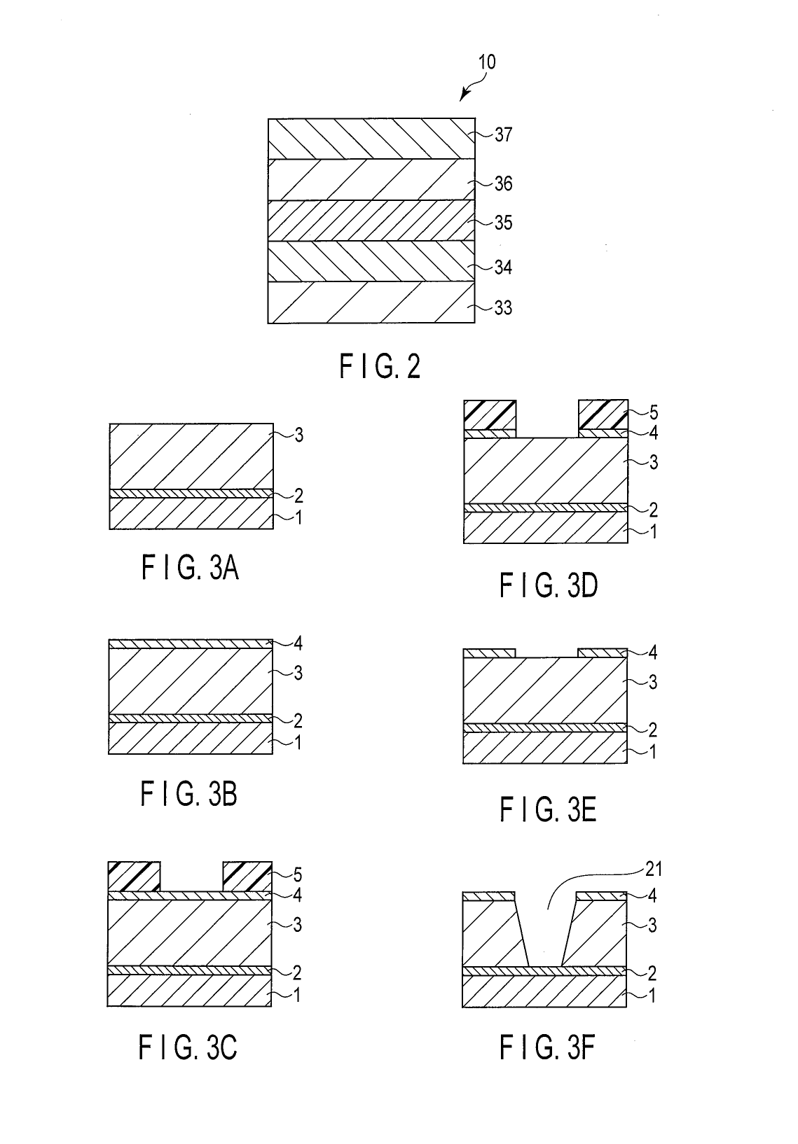

FIG. 2 is a sectional view showing the arrangement of an embodiment of the STO layer.

As shown in FIG. 2, the STO layer 10 includes an field generation layer 34, a spin injection layer 36, an interlayer 35 formed between the field generation layer 34 and spin injection layer 36, an underlayer 33 formed as the lowermost layer, and a cap layer 37 formed as the uppermost layer. As the field generation layer 34, an FeCoAl alloy having magnetic anisotropy in the film longitudinal direction can be used. It is also possible to use a material to which at least one of Si, Ge, Mn, Cr, and B is added. This makes it possible to adjust the Bs, Hk (anisotropic magnetic field), and spin torque transmission efficiency between the oscillation layer 34 and spin transfer layer 36. As the interlayer 35, a material having a high spin transmittance such as Cu, Au, or Ag can be used. The thickness of the interlayer 35 can be one atomic layer to 3 nm. This makes the exchanging coupling between the field generation layer 34 and spin injection layer 36 adjustable to an optimum value. As the spin injection layer 36, it is possible to use a material having high perpendicular alignment, e.g., a CoCr-based magnetic layer such as CoCrPt, CoCrTa, CoCrTaPt, or CoCrTaNb, an RE-TM-based amorphous alloy magnetic layer such as TbFeCo, a Co-based superlattice materials such as Co/Pd, Co/Pt, or CoCrTa/Pd, a CoPt-based or FePt-based alloy magnetic layer, or an SmCo-based alloy magnetic layer, a soft magnetic layer having a relatively high saturation magnetic flux density and magnetic anisotropy in the film longitudinal direction, e.g., CoFe, CoNiFe, NiFe, CoZrNb, FeN, FeSi, or FeAlSi, a Heusler alloy selected from the group consisting of CoFeSi, CoMnSi, and CoMnAl, or a CoCr-based magnetic alloy film in which magnetization is aligned in the film longitudinal direction. It is also possible to use a stack of a plurality of the above-mentioned materials. As the under layer 33 and cap layer 37, it is possible to use a nonmagnetic metal material having a low electrical resistance, e.g., Ti, Cu, Ru, or Ta.

Furthermore, as shown in FIG. 1P, after the STO 10 is deposited, a CMP planarizing process is performed to remove the STO 10 deposited on the insulating layer 9. IBE may also be used in this removal.

As shown in FIG. 1Q, after the extra STO on the insulating layer is removed by CMP, a seed layer 11 is formed, and a write shield 12 is formed by, e.g., plating through the seed layer 11. The seed layer 11 for plating can be a nonmagnetic metal material having high conductivity, and Ru or the like can be used. The write shield must be a soft magnetic material that readily absorbs a magnetic flux, so it is possible to use an alloy containing Ni, Fe, and Co.

In the magnetic recording head manufacturing processes according to the first embodiment, as shown in, e.g., FIG. 1O, the STO is buried in the gap 14 formed on the main pole 7 and formed into a predetermined pattern, so the sidewalls of the STO are not exposed to dry etching such as ion beam etching. In a high-frequency assisted magnetic recording head manufactured by the above method, the critical current density Jc required for oscillation can be suppressed because there is no redeposited product of the main pole material, which suppresses the oscillation of the STO. Accordingly, it is possible to maximally utilize a high-frequency magnetic field of the STO, and increase the recording gain.

### Second Embodiment

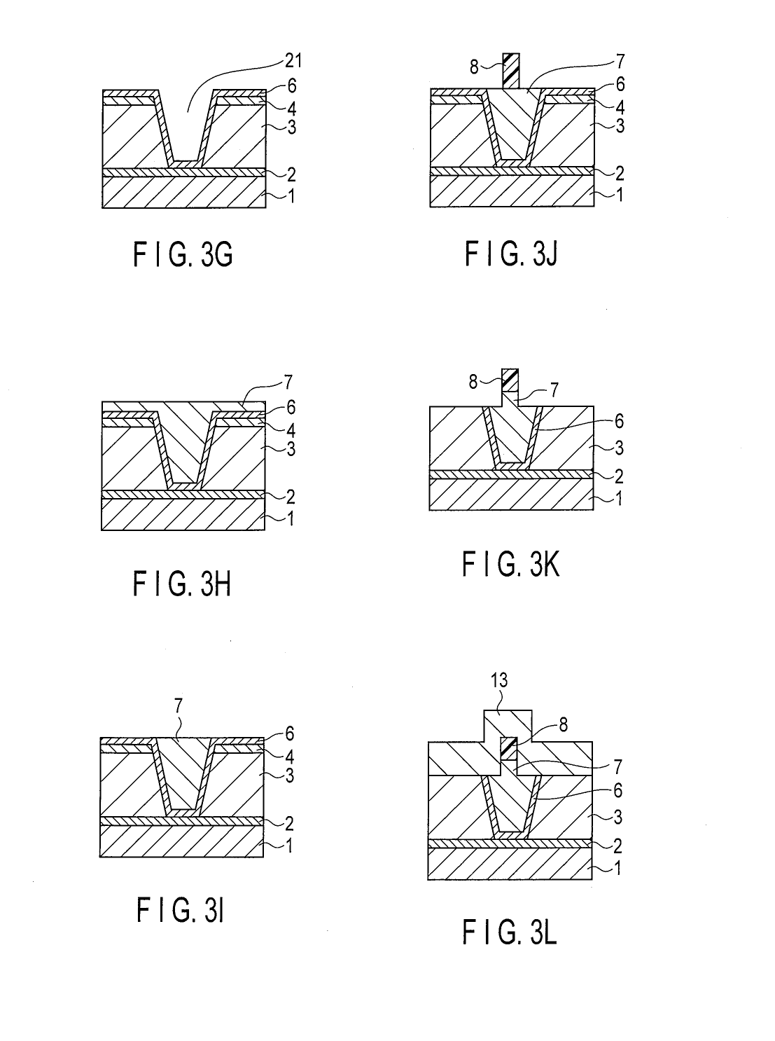

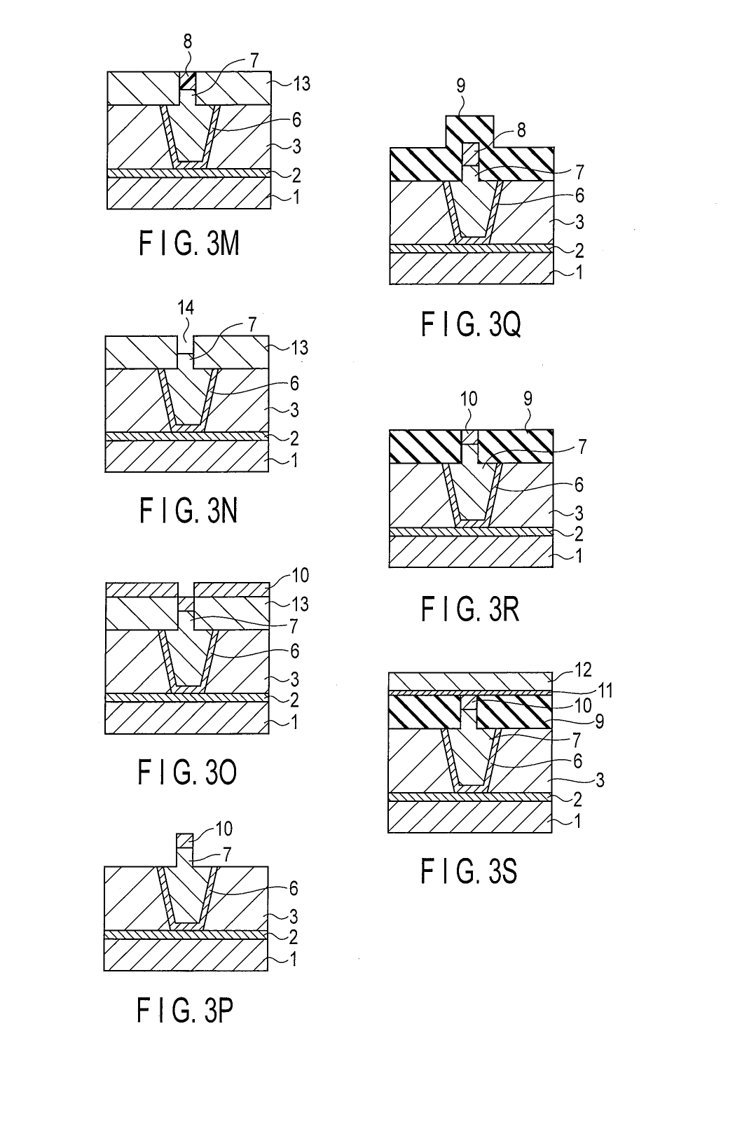

FIGS. 3A, 3B, 3C, 3D, 3E, 3F, 3G, 3H, 3I, 3J, 3K, 3L, 3M, 3N, 3O, 3P, 3Q, 3R, and 3S are views showing magnetic recording head manufacturing processes according to the second embodiment.

As shown in FIGS. 3A, 3B, 3C, 3D, 3E, 3F, 3G, 3H, 3I, 3J, and 3K, as in the processes shown in FIGS. 1A, 1B, 1C, 1D, 1E, 1F, 1G, 1H, 1I, 1J, and 1K, a stopper layer 2 is formed on a substrate 1, an Al₂O₃ layer 3 is formed on the etch stopper layer 2, a trench is formed in the Al₂O₃ layer 3, a seed layer 6 is formed on the trench surface, a main pole 7 is formed in the trench through the seed layer 6, the upper portion of the main pole 7 is etched to a predetermined depth, and a mask 8 for scraping the main pole 7 is formed on it.

After the metal mask 4, seed layer 6, and main pole 7 are etched by etching as shown in FIG. 3K, a release layer 13 for filling the etched portion is formed as shown in FIG. 3L. This release layer can be deposited by taking account of the thickness of an STO to be formed later. As the release layer, it is possible to use Mo or W that dissolves in a dilute aqueous solution (acid solution) of hydrogen peroxide (H₂O₂), a compound of Mo or W, Al that dissolves in a dilute aqueous solution (alkali solution) of sodium hydroxide (NaOH), or an Al compound. Also, since photoresist removal is performed later, it is important to select the material so as to remove only the resist.

Then, as shown in FIG. 3M, a planarizing process is performed by using, e.g., CMP in the same process as shown in FIG. 1M.

Subsequently, as shown in FIG. 3N, a gap 14 for forming an STO can be formed by removing the mask 8. This realizes a state in which an STO can be formed in self-alignment. As this removal, it is possible to use wet removal using a solution that dissolves the photoresist, or dry removal such as RIE using a reactive gas.

After that, as shown in FIG. 3O, an STO 10 is formed on the main pole 7 after the photoresist is removed, in the same manner as in the process shown in FIG. 1O.

As shown in FIG. 3P, after the STO 10 is deposited, the release layer 13 is removed by a wet process by which the release layer 13 is dipped in the above-mentioned aqueous solution. The extra STO film on the release layer 13 can also be removed by removing the release layer 13. It is also possible to simultaneously remove the STO film deposited on the sidewalls of the gap 14 in the release layer 3.

As shown in FIG. 3Q, an insulating layer 9 is formed on the Al₂O₃ layer 3, main pole 7, and STO 10.

After that, as shown in FIG. 3R, the insulating layer 9 is planarized until the surface of the STO 10 is exposed. The surface of the STO 10 can be exposed by performing the planarizing process by using, e.g., CMP, but IBE may also be used.

Furthermore, as shown in FIG. 3S, a seed layer 11 is formed, and a write shield 12 is formed by, e.g., plating through the seed layer 11, in the same manner as in the process shown in FIG. 1Q.

In the magnetic recording head manufacturing processes according to the second embodiment, as shown in, e.g., FIG. 3O, the STO is buried in the gap 14 formed on the main pole 7 and formed into a predetermined pattern, so the sidewalls of the STO are not exposed to dry etching. Therefore, the critical current density Jc required for oscillation can be suppressed because no redeposited product adheres to the sidewalls of the STO when processing the main pole. Accordingly, it is possible to maximally utilize a high-frequency magnetic field of the STO, and increase the recording gain.

### Third Embodiment

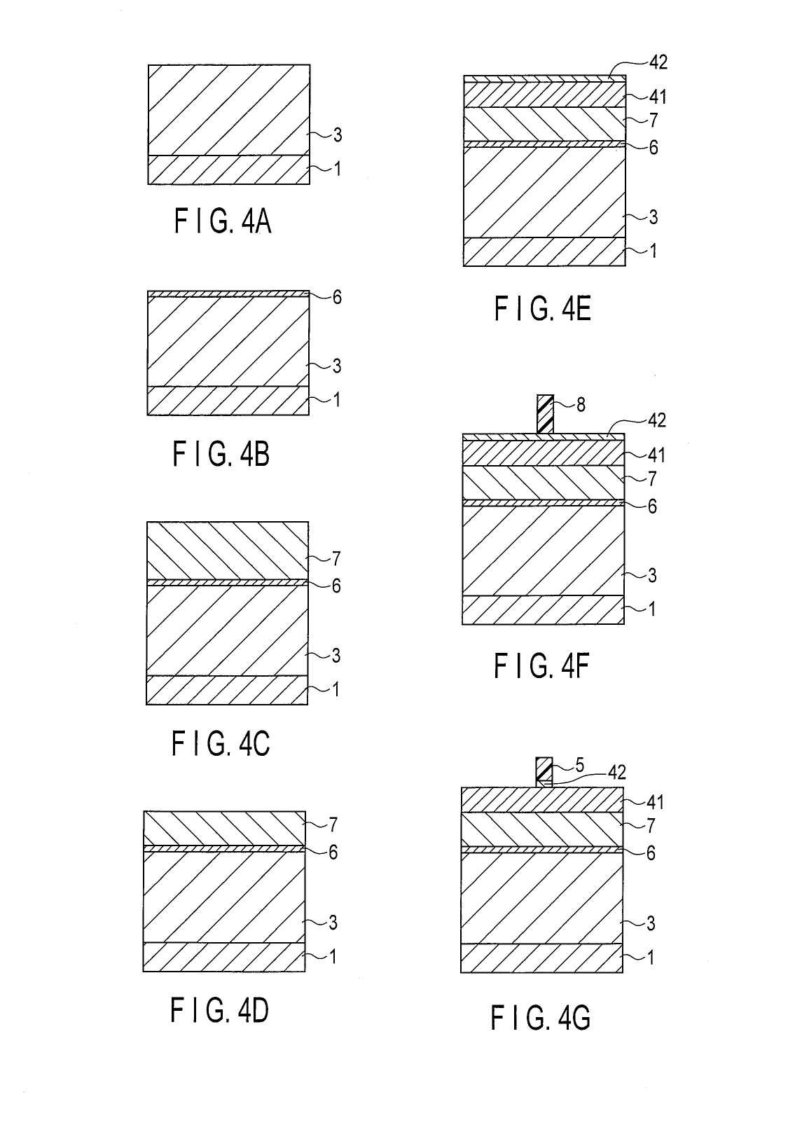

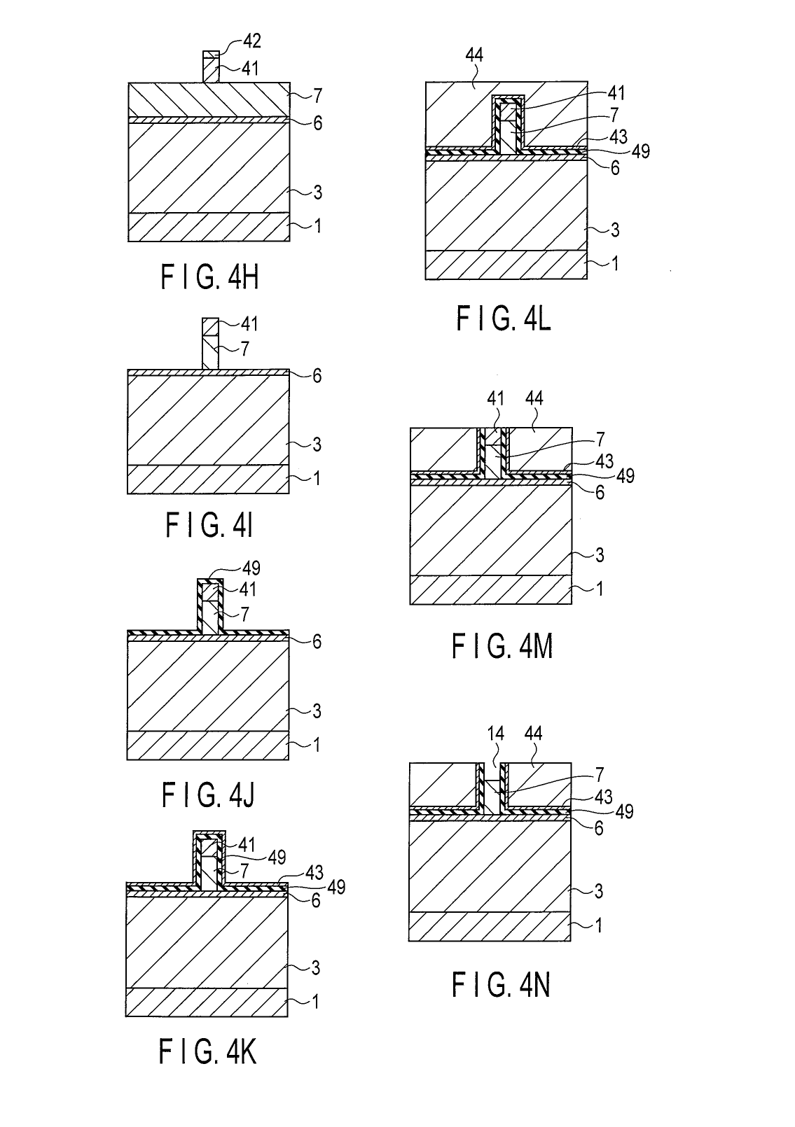

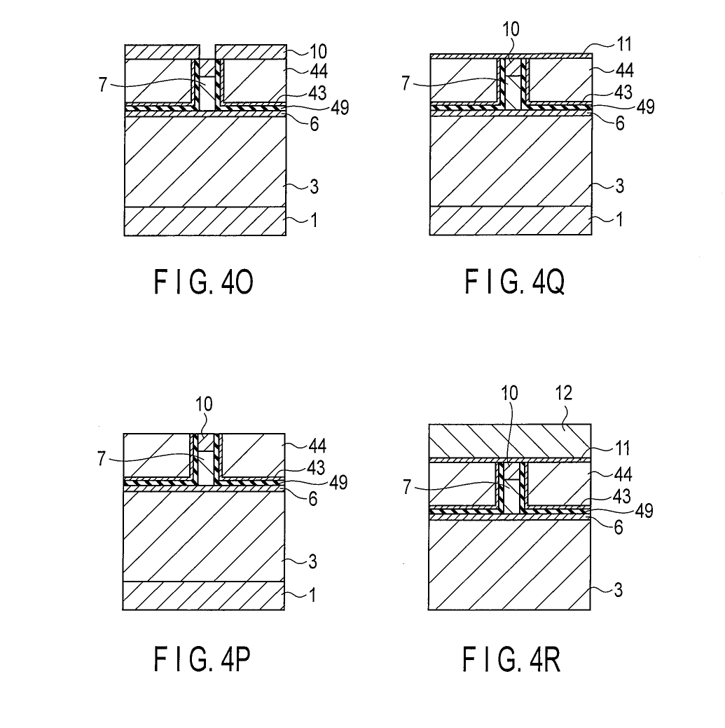

FIGS. 4A, 4B, 4C, 4D, 4E, 4F, 4G, 4H, 4I, 4J, 4K, 4L, 4M, 4N, 4O, 4P, 4Q, and 4R are views showing magnetic recording head manufacturing processes according to the third embodiment.

First, as shown in FIG. 4A, an Al₂O₃ layer 3 is formed on a substrate 1 identical to that shown in FIG. 1A.

Then, as shown in FIG. 4B, a seed layer 6 is formed on the Al₂O₃ layer 3. As the seed layer 6, a nonmagnetic metal having high conductivity can be used. An example is Ru.

Subsequently, as shown in FIG. 4C, a main pole 7 is formed by plating after the seed layer 6 is formed. Although the main pole 7 is formed by sputtering in this embodiment, a dry process such as sputtering may also be used. Since the main pole 7 is required to have a high saturation magnetic flux density (Bs), alloys of Fe, Co, and Ni can be used.

As shown in FIG. 4D, after the main pole 7 is formed, the surface is planarized by CMP in order to planarize the surface of the main pole 7. After that, as shown in FIG. 4E, a hard mask is deposited as a mask for patterning the main pole 7. As the hard mask, it is possible to use, e.g., C, Si, Al, and oxides and nitrides of these elements. In this embodiment, hard masks 41 and 42 made of C and Si are used. Accordingly, a pattern of a photoresist to be patterned on the hard masks 41 and 42 later can be transferred with a high aspect, so a hard mask pattern having a high etching resistance can be formed. A hard mask is generally superior in resistance against RIE or IBE than a photoresist for use in photolithography, and has advantages that deep etching can be performed and a processing margin can be ensured.

As shown in FIG. 4F, a mask 8 is formed on the main pole 7 in order to perform patterning for etching the main pole 7 on the hard mask 42. Photolithography, electron beam lithography, or the like is used as this patterning. A photoresist is an example of the mask 8.

As shown in FIGS. 4G and 4H, the pattern formed by the photoresist is transferred to the hard masks 41 and 42. This hard mask transfer is performed by RIE using a reactive gas. By using the double-layer arrangement as the hard mask as in this embodiment and properly selecting the material in accordance with the reactive gas, the hard masks 41 and 42 having a high aspect ratio can be formed by etching the upper hard mask 42 (Si) by using the photoresist as a mask, and etching the lower hard mask 41 (C) by using the upper hard mask 42 (Si) as a mask.

Subsequently, as shown in FIG. 4I, the main pole 7 is etched by IBE through the hard mask 41.

In addition, as shown in FIG. 4J, a side gap layer 49 is formed as an insulating layer in order to obtain electrical insulation with a side shield to be formed later. The side gap layer 49 can be formed by using ALD (Atomic Layer Deposition) by which a layer is sufficiently deposited on sidewalls, in order to evenly deposit the layer on a projection obtained by processing the main pole 7. As the side gap layer 49, it is possible to use an oxide of Al or Si such as Al₂O₃ or SiO₂, or a nitride of Al or Si such as AlN or SiN.

As shown in FIG. 4K, a seed layer 43 is formed on the side gap layer 49. As the seed layer 43, a nonmagnetic metal having high conductivity can be used. An example is Ru.

As shown in FIG. 4L, a side shield layer 44 is formed by plating after the seed layer 43 is formed. To cover the sidewalls of the main pole 7, the thickness of the side shield layer 44 is adjusted with respect to the thickness of the main pole 7. A soft magnetic material that readily absorbs a magnetic flux can be used as the side shield layer 44, and alloys materials of Ni, Fe, and Co are used.

After that, as shown in FIG. 4M, the side shield layer 44 is planarized until the surface of the hard mask 41 is exposed. For example, the surface of the hard mask 41 can be exposed by performing the planarizing process by using CMP. It is also possible to use IBE.

Subsequently, as shown in FIG. 4N, the hard mask 41 is removed. As this removal, dry removal using a reactive gas can be used.

Furthermore, as shown in FIG. 4O, an STO 10 is formed on the main pole 7. Since the STO 10 is buried in the gap 14 formed by removing the hard mask 41, it is deposited by using IBD (Ion Beam Deposition) as a deposition method having high atomic linearity, thereby suppressing deposition to the sidewalls of the gap 14.

As shown in FIG. 4P, after the STO 10 is deposited, a CMP planarizing process is performed to remove the STO 10 deposited on the side shield layer 44. IBE may also be used in this removal.

As shown in FIG. 4Q, a seed layer 11 is formed on the STO 10 and side shield layer 44.

Finally, as shown in FIG. 4R, a write shield 12 is formed by plating through the seed layer 11. The seed layer 11 for plating can be a nonmagnetic metal material having high conductivity, and Ru or the like can be used. The write shield must be a soft magnetic material that readily absorbs a magnetic flux, so it is possible to use an alloy containing Ni, Fe, and Co.

In the magnetic recording head manufacturing processes according to the third embodiment, as shown in, e.g., FIG. 4O, the STO is buried in the gap 14 formed on the main pole 7 and formed into a predetermined pattern, so the sidewalls of the STO are not exposed to dry etching such as ion beam etching. Therefore, the critical current density Jc required for oscillation can be suppressed because no redeposited product adheres to the sidewalls of the STO when processing the main pole. Accordingly, it is possible to maximally utilize a high-frequency magnetic field of the STO, and increase the recording gain. In addition, the fringe characteristic improves because the side shield is formed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording head manufacturing method comprising:
forming a main pole;
forming, on the main pole, an insulating layer having a gap for forming a spin torque oscillator;
forming a spin torque oscillator in the gap; and
forming an auxiliary magnetic pole on the spin torque oscillator.

2. The method according to claim 1, wherein the forming the insulating layer having the gap comprises:
forming a mask layer on the main pole;
patterning the main pole through the mask layer;
forming an insulating layer on the main pole and the mask layer;
exposing the mask layer by partially removing the insulating layer; and
removing the mask layer to form a gap for forming a spin torque oscillator in the insulating layer.

3. The method according to claim 2, wherein the mask layer is one of a resist layer and a hard mask layer.

4. The method according to claim 1, wherein the forming the spin torque oscillator in the gap comprises:
forming a spin torque oscillator on the insulating layer having the gap by ion beam sputtering; and
removing the spin torque oscillator formed in a region except for the gap by scraping the spin torque oscillator.

5. The method according to claim 1, wherein the forming the main pole comprises forming a main pole in a trench formed in a nonmagnetic layer.

6. The method according to claim 1, further comprising forming a magnetic shield layer on the insulating layer, and partially removing the magnetic shield layer, before the exposing the mask layer by partially removing the insulating layer.
